(19) United States
(12) Patent Application Publication
(10) Pub. No.: US 2011/0116893 A1
(43) Pub. Date: May 19, 2011

(54) CONNECTION STRUCTURE FOR SHEET-METAL PARTS AND IMAGE FORMING APPARATUS

(75) Inventors: Kenichi Hayashi, Tokyo (JP); Isao Watanabe, Toyohashi-shi (JP); Toshikuni Ando, Toyokawa-shi (JP); Kiyohito Tsujihara, Toyokawa-shi (JP)

(73) Assignee: Konica Minolta Business Technologies, Inc., Tokyo (JP)

(21) Appl. No.: 13/003,734

(22) PCT Filed: Jul. 30, 2009
(86) PCT No.: PCT/JP2009/063554

§ 371 Date: Jan. 11, 2011

(30) Foreign Application Priority Data
Sep. 5, 2008 (JP) 2008-228155

(51) Int. Cl. F16B 35/00

(52) U.S. Cl. 411/378

(57) ABSTRACT

An object of the present invention is to provide a connection structure for sheet-metal parts that permits two sheet-metal parts to be screwed to each other with good conductivity by a simple process in a simple structure, and an image forming apparatus provided with the connection structure.

Disclosed is a connection structure for connecting a first sheet-metal part (31) to a second sheet-metal part (41) by placing the sheet-metal parts (31) and (41) such that their respective contact surfaces face to each other and by connecting the contact surfaces by a screw (50). A first pilot hole (32) that is smaller than the screw (50) is made in the first sheet-metal part (31), and a plurality of first small holes (33) that are smaller than the first pilot hole (32) are made in the first sheet-metal part (31), around the first pilot hole (32). In a process of connecting the first sheet-metal part (31) and the second sheet-metal part (41) together, when the screw (50) is tightened into the first pilot hole (32), force acts on the first sheet-metal part (31), around the first pilot hole (32). The first small holes (33) are pushed by the force, and projections are formed at the first small holes (33). Then, the projections come into contact with the second sheet-metal part (41).

### REFERENCE TO RELATED APPLICATIONS

This application is a national stage application under 35 USC 371 of International Application No. PCT/JP2009/063554, filed Jul. 30, 2009, which claims the priority of Japanese Application No. 2008-228155, filed Sep. 5, 2008, the contents of which prior applications are incorporated herein by reference.

### FIELD OF THE INVENTION

The present invention relates to a connection structure for sheet-metal parts and more particularly to a connection structure for connecting two sheet-metal parts by putting the two parts such that contact surfaces of the respective parts face to each other and by connecting the contact surfaces to each other by a screw, and an image forming apparatus, such as a copying machine or a printer, provided with the connection structure.

### BACKGROUND OF THE INVENTION

In image forming apparatuses, such as copying machines, printers and facsimiles, and various kinds of electric and electronic appliances, such as computers and communication devices, conventionally, various components and units are tied up in a metal framework of the apparatus, and an outer covering is set over the framework.

In order to assemble the metal framework, at present, sheet-metal parts are put such that contact surfaces of the respective parts face to each other, and the contact surfaces are fastened to each other by a screw, a rivet or any other fastening member or are welded together. The metal framework is also used for grounding so as to suppress electrostatic and EMI (noise).

Meanwhile, for sheet-metal parts, conventionally, zinc-treated steel sheets coated with hexavalent chromium, which has a corrosion prevention effect, are used. However, since hexavalent chromium is a cause of environmental degradation, reconsideration of the use of hexavalent chromium is required globally.

Recently, therefore, as a substitute for zinc-treated steel sheets, steel sheets with a resin coating and not containing hexavalent chromium (chromium-free steel sheets) have been developed to be used for frameworks of devices and appliances. The resin coating is a thin insulating resin film with a thickness of about several micrometers and has a corrosive prevention effect.

In connecting metal-sheet parts made of chromium-free steel sheets coated with insulating resin, because of the insulating resin existing between the contact surfaces of the respective parts, the conductivity between the metal-sheet parts is poor. In this case, also, the grounding of the whole framework is not good, and it is difficult to take sufficient measures to suppress electrostatic and EM!. Further, because of the trend that the frequencies of electronic devices are getting higher, even when metal-sheet parts made of conventional zinc-treated steel sheets are connected together by an ordinary connection structure, it may not be possible to suppress EMI satisfactorily.

In order to solve these problems, for example, patent document 1 teaches that sheet-metal parts having knurled portions on the respective contact surfaces are directly joined together with the knurled portions engaging with each other. Patent document 2 teaches that sharp projections are made near screw holes of sheet-metal parts so as to scratch the contact surfaces of the sheet-metal parts to remove the coatings of the contact surfaces, thereby stabilizing the contact reliability. In this method, however, it is necessary to execute a difficult process of forming projections on sheet-metal parts by use of a special tool, which also results in a rise in the cost.
Patent Document 1: Japanese Patent Laid-Open Publication No. 2003-233154
Patent Document 2: Japanese Patent Laid-Open Publication No. 2004-055731

### SUMMARY OF THE INVENTION

An object of the present invention IS to provide a connection structure for sheet-metal parts that permits two sheet-metal parts to be screwed to each other with good conductivity by a simple process in a simple structure, and an image forming apparatus provided with the connection structure.

In order to attain the object, according to an embodiment of the present invention,

a connection structure for connecting a first-sheet metal part to a second sheet-metal part by placing the first sheet-metal part and the second sheet-metal part such that a contact surface of the first sheet-metal part and a contact surface of the second sheet-metal part

face to each other and by connecting the contact surfaces together by a screw comprises:

a first pilot hole made in the first sheet-metal part and at least one first small hole made in the first sheet-metal part, around the first pilot hole, the first pilot hole being smaller than the screw and the first small hole being smaller than the first pilot hole,

wherein when the first sheet-metal part and the second sheet-metal part are connected together by the screw, a projection is formed at the first small hole by force caused by tightening of the screw into the first pilot hole and applied to around the first pilot hole, and the projection comes into contact with the second sheet-metal part.

In the structure according to the present invention, when the screw is screwed into the first pilot hole, force acts on the first sheet-metal part, around the first pilot hole. The first small hole is pushed by the force and is closed, and a projection is formed. The projection comes into contact with the second sheet-metal part. Thereby, even when the first sheet-metal part and the second sheet-metal part are coated with insulating resin, these parts can be connected to each other with good conductivity. Then, the grounding is good, and the measure to suppress EMI becomes effective.

### BRIEF DESCRIPTION OF THE DRAWINGS

FIG. 1 is a schematic view of an image forming apparatus according to an embodiment of the present invention.

FIG. 2 is a sectional view of a connection structure according to a first embodiment of the present invention.

FIG. 3 is a perspective view of the connection structure according to the first embodiment.

FIG. 4 is an illustration showing a connecting process in the connection structure according to the first embodiment.

FIG. 5 is a perspective view of a connection structure according to a second embodiment of the present invention.

FIG. 6 is a sectional view of the connection structure according to the second embodiment.

FIG. 7 is a sectional view showing punching of small holes.

FIG. 8 is a perspective view showing the punching of small holes.

FIG. 9 is a perspective view of a connection structure according to a third embodiment of the present invention.

### DETAILED DESCRIPTION OF THE INVENTION

Connection structures for sheet-metal parts and image forming apparatuses according to preferred embodiments of the present invention are described, with reference to the accompanying drawings.

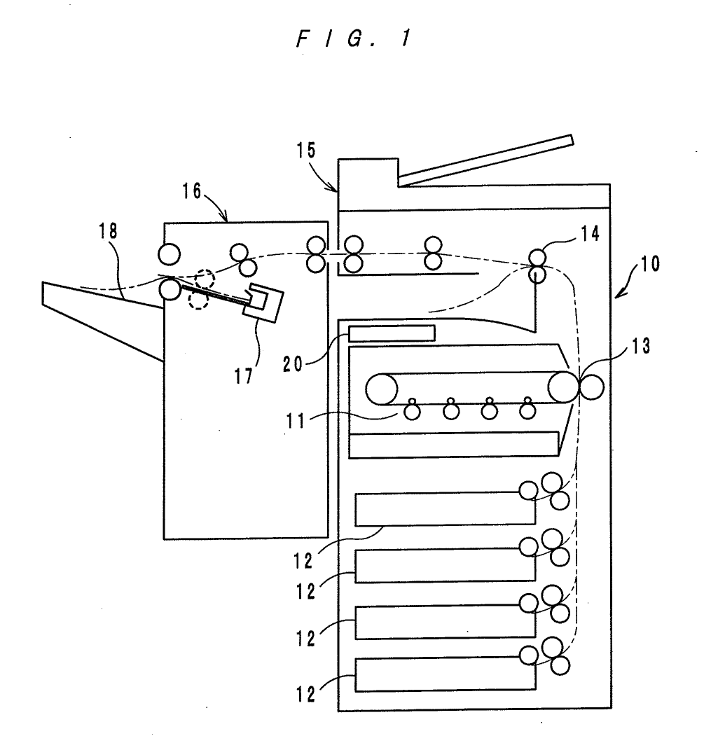

First, referring to FIG. 1, an image forming apparatus according to an embodiment of the present invention is described. FIG. 1 shows the general structure of an electrophotographic image forming system. This system comprises a printer body 10, an image reader 15, a finisher 16 having a stapler 17 and other devices, and a controller 20 for controlling the whole system.

Document image data read out by the image reader 15 or image data transmitted from a host computer are inputted into the controller 20, and based on the image data, a toner image is formed in an image forming station 11, which comprises photosensitive drums and other image forming elements. Sheets are fed one by one from one of four sheet feed cassettes 12. The toner image is transferred to the sheet at a transfer position 13, and the toner image is fixed on the sheet at a fixing unit 14. Thereafter, the sheet is subjected to a necessary finishing process, for example, a stapling process at the finisher 16 and is ejected onto a tray 18. The printer body 10 is so structured that a full color image is formed by a tandem system. The structure and the image forming process of this type of printer are well known, and the descriptions thereof are omitted.

A crystal unit and a clock generator are mounted on a control circuit board of the controller 20 to activate a CPU, and the mounting of these elements is the cause of noise such as EM!. In order to suppress the noise, noise suppression parts such as an EMI filter and a capacitor are also mounted on the control circuit board. Additionally, a metal structure that is the framework of the printer body 10 is entirely grounded evenly so that the EMI noise will not radiate to the outside.

Thus, in order to obtain the EMI noise suppression effect and to ensure the strength of the printer body 10, most of the structure and the electric components of the printer body 10 are composed of sheet-metal parts. In order to connect the sheet-metal parts, mostly, screws are used because screwing has advantages in the workability and in the cost. For the sheet-metal parts, zinc-coated steel sheets and chromium-free steel sheets with an insulating resin coating on a metal surface are used.

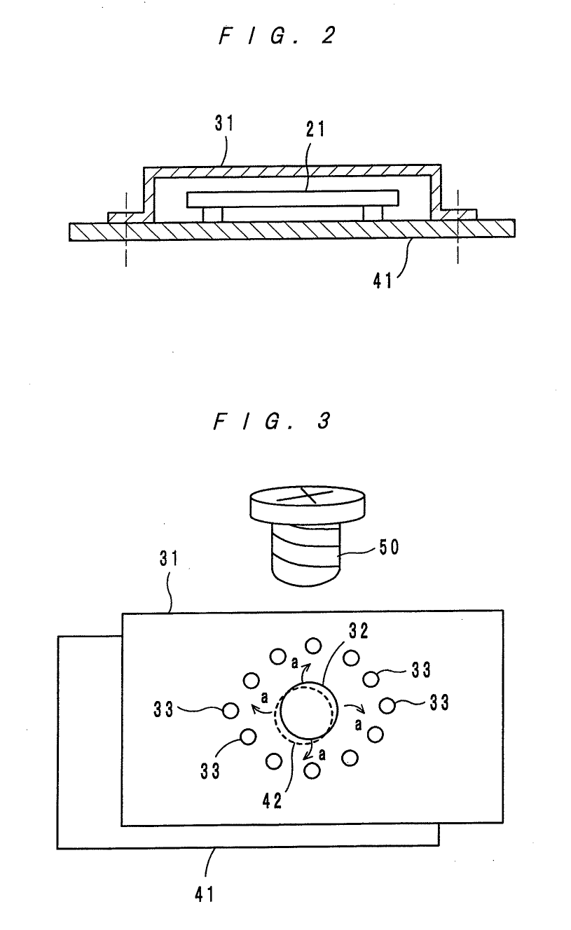

The controller 20, the sheet feed cassettes 12, the finisher 16 and some other sections each have a control circuit board. As shown by FIG. 2, such a control circuit board 21 is fixed to a sheet-metal part 41 (which will be hereinafter referred to as a second sheet-metal part) that is a part of the framework and is covered by a shield cover 31 (which will be hereinafter referred to as a first sheet-metal part). A connection structure according to a first embodiment of the present invention is to connect the first sheet-metal part 31 to the second sheet-metal part 41 with electrical conductivity ensured.

As shown by FIG. 3, a first pilot hole 32 is made in the first sheet-metal part 31, and around the pilot hole 31, a plurality of first small holes 33 are made. The. first pilot hole 32 has a smaller diameter than a screw 50, and the first small holes 33 have a smaller diameter than the first pilot hole 32. For example, the screw 50 has a diameter of 3 mm, the first pilot hole 32 has a diameter of 2.5 mm, and the first small holes 33 have diameters of 0.5 mm. The first small holes 33 are made at distances of 1 mm from the first pilot hole 32.

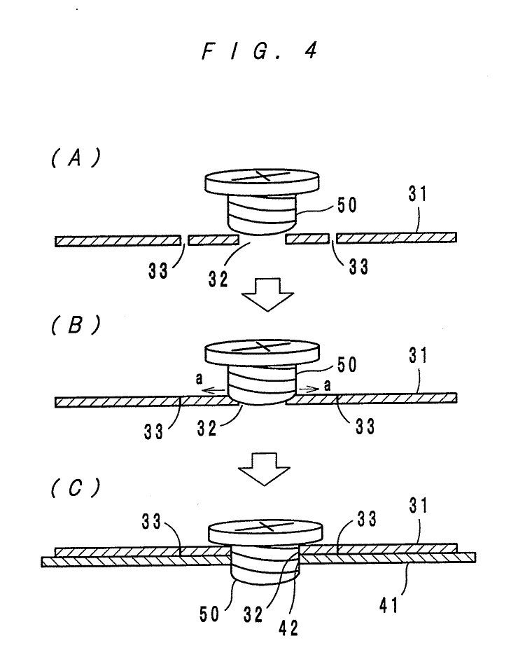

FIG. 4 shows a process of connecting the first sheet-metal part 31 to the second sheet-metal part 41 by the screw 50. As shown by FIG. 4(A), the screw 50 is screwed into the first pilot hole 32 that is smaller than the screw 50. In the meantime, force acts on the first sheet-metal part 31, around the first pilot hole 32, in directions “a” shown in FIGS. 3 and 4(B), and thereby, this portion of the first sheet-metal part 31 is pushed out and is deformed radically. Due to the force in the radical direction, the first small holes 33 are pushed and closed, and further, projections toward the second sheet-metal part 41 are formed. These projections come into contact with the second sheet-metal part 41, and even when the second sheet-metal part 41 is coated with an insulating resin film, the projections peel off the resin film at the contact portions. Thereby, the first sheet-metal part 31 and the second sheet-metal part 41 can be connected to each other with the resin film scratched off (see FIG. 4(C)). Consequently, the sheet-metal parts 31 and 41 are connected to each other with good conductivity, and grounding and good EMI suppression effect are ensured.

A second pilot hole 42 is made in the second sheet-metal part 41, and the second pilot hole 42 has a smaller diameter than the screw 50. However, the second pilot hole 42 may be larger than the screw 50, and in this case, a nut to engage with the screw 50 is necessary.

The first small holes 33 are formed by punching a plated or coated steel sheet, and therefore, the edges of the first small holes 33 are not coated with an insulating resin film. While the screw 50 is screwed into the first pilot hole 32, the first small holes 33 are pushed, and projections are formed at the small holes 33. Then, the projections come into contact with and scratch the contact surface of the second sheet-metal part 41, that is, the first sheet-metal part 31 makes contacts with the second sheet-metal part 41 at a large number of points. Thus, even when the second sheet-metal part 41 is made of chromium-free sheet metal with an insulating resin coating, the insulating resin coating can be peeled off, which ensures stable conductivity between the sheet-metal parts 31 and 41.

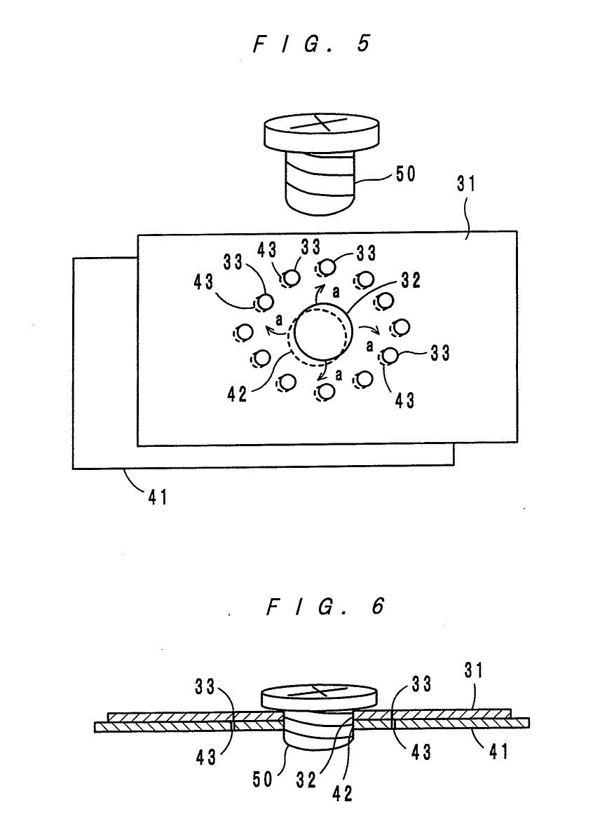

As shown by FIG. 5, in a connection structure according to a second embodiment, further, a second pilot hole 42 having a smaller diameter than the screw 50 is made in the second sheet-metal part 41, and second small holes 43 are made at positions to face to the first small holes 33. In the second embodiment also, the process of connecting the sheet-metal parts 31 and 41 by the screw 50 is carried out as shown by FIG. 4. In the second embodiment, since the edges of the second small holes 43 are not coated with an insulating resin film, the electrical conductivity between the first sheet-metal part 31 and the second sheet-metal part 41 after the connection is better.

Since the second pilot hole 42 has a smaller diameter than the screw 50, when the screw 50 is tightened, force acts on the second sheet-metal part 41, around the second pilot hole 42. The second small holes 43 are pushed by the force and are closed, and projections are formed. These projections collide with the projections formed at the positions of the first small holes 33, and better electrical conductivity between the sheet-metal parts 31 and 41 is ensured.

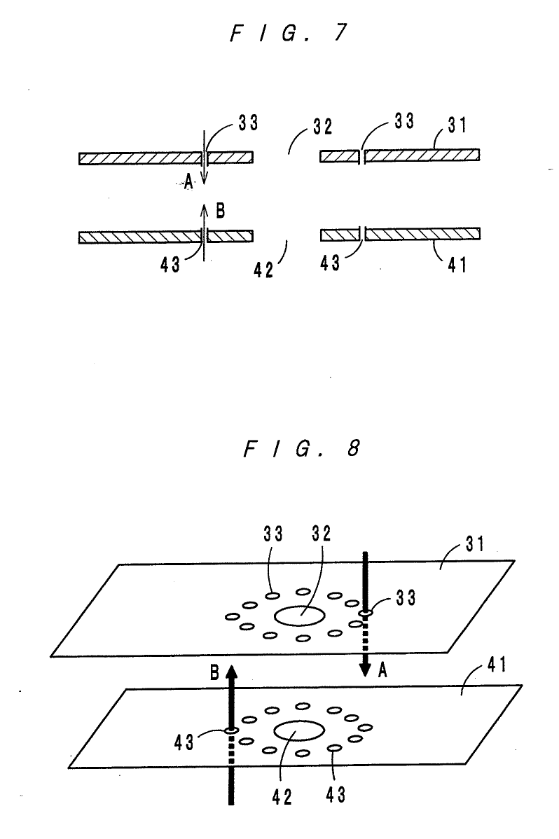

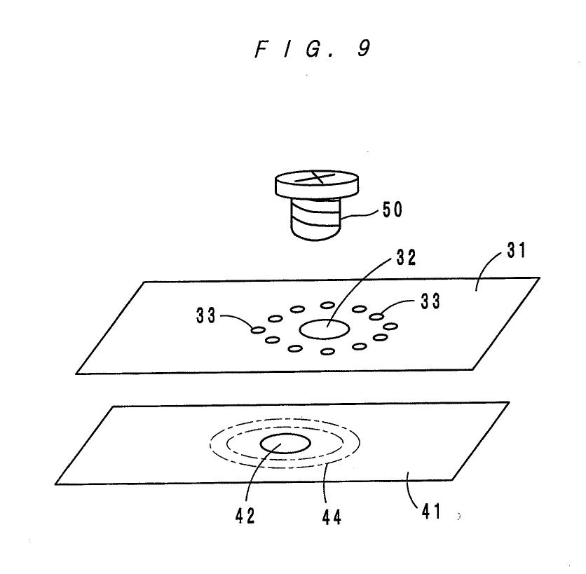

As shown by FIGS. 7 and 8, the first small holes 33 are preferably made by punching in a direction toward the second sheet-metal part 41 (see arrow “A”), and the second small holes 43 are preferably made by punching in a direction toward the first sheet-metal part 31 (see arrow “B”). In a punching process, usually, burrs protrude and/or rollovers appear in a direction in which punching is executed. Therefore, by executing punching in the directions “A” and “B”, projections are formed to extend from the sheet-metal parts 31 and 41 to each other, which contributes to good electrical contact between the sheet-metal parts 31 and 41 without an insulating resin film in-between.

As shown by FIG. 9, in a connection structure according to a third embodiment, the contact surface of the second sheet-metal part 41 has a knurled portion 44 at a position to face to the first small holes 33. Knurling is a well-known process of making grooves on a surface of a workpiece by rotating a knurling tool fastened to a lathe.

In the third embodiment, the projections formed at the small holes 33 scrape against the knurled portion 44, and thereby, the first sheet-metal part 31 and the second sheet-metal part 41 are connected to each other with good electrical conductivity therebetween.

The connection structure and the image forming apparatus according to the present invention are not limited to the preferred embodiments above, it is to be noted that various changes and modifications are possible. Such changes and modifications are to be understood as being within the scope of the invention.

As described above, the present invention is advantageous when it is applied to a connection structure for sheet-metal parts and to an image forming apparatus. The present invention is advantageous especially in that two sheet-metal parts can be screwed to each other with good conductivity by a simple process in a simple structure.

### DESCRIPTION OF THE REFERENCE SYMBOLS

10: printer body
31: first sheet-metal part
32: first pilot hole
33: first small holes
41: second sheet-metal part
42: second pilot hole
43: second small holes
44: knurled portion

1. A connection structure for connecting a first-sheet metal part to a second sheet-metal part by placing the first sheet-metal part and the second sheet-metal part such that a contact surface of the first sheet-metal part and a contact surface of the second sheet-metal part face to each other and by connecting the contact surfaces together by a screw, comprising:
a first pilot hole made in the first sheet-metal part and at least one first small hole made in the first sheet-metal part, around the first pilot hole, the first pilot hole being smaller than the screw and the first small hole being smaller than the first pilot hole,
wherein when the first sheet-metal part and the second sheet-metal part are connected together by the screw, a projection is formed at the first small hole by force caused by tightening of the screw into the first pilot hole and applied to around the first pilot hole, and the projection comes into contact with the second sheet-metal part.

2. A connection structure according to claim 1, wherein:
an insulating resin coating is provided for the second sheet-metal part, on at least the contact surface; and
the second sheet-metal part comes into contact with the projection at a position where the insulating resin coating is peeled off by the projection.

3. A connection structure according to claim 1, wherein the first small hole is made by punching in a direction toward the second sheet-metal part.

4. A connection structure according to claim 1, wherein the first small hole has a diameter smaller than that of the first pilot hole.

5. A connection structure according to claim 1, further comprising a second pilot hole made in the second sheet-metal part, the second pilot hole being smaller than the screw.

6. A connection structure according to claim 5, further comprising a second small hole made in the second sheet-metal part, at a position to face to the first small hole.

7. A connection structure according to claim 6, wherein the second small hole is made by punching in a direction toward the first sheet-metal part.

8. A connection structure according to claim 6, wherein the second small hole has a diameter smaller than that of the second pilot hole.

9. A connection structure according to claim 1, wherein the second sheet-metal part has a knurled portion on the contact surface, at a position to face to the first small hole.

10. An Image forming apparatus comprising:
a first sheet-metal part;
a second sheet-metal part connected to the first sheet-metal part by placing the first sheet-metal part and the second sheet-metal part such that a contact surface of the first sheet-metal part and a contact surface of the second sheet-metal part face to each other and by connecting the contact surfaces together by a screw;
wherein:
a first pilot hole and at least one first small hole are made in the first sheet-metal part such that the first small hole is located around the first pilot hole, the first pilot hole being smaller than the screw and the first small hole being smaller than the first pilot hole; and
when the first sheet-metal part and the second sheet-metal part are connected together by the screw, a projection is formed at the first small hole by force caused by tightening of the screw into the first pilot hole and applied to around the first pilot hole, and the projection comes into contact with the second sheet-metal part.

11. An image forming apparatus according to claim 10, wherein:
an insulating resin coating is provided for the second sheet-metal part, on at least the contact surface; and
the second sheet-metal part comes into contact with the projection at a position where the insulating resin coating is peeled off by the projection.

12. An image forming apparatus according to claim 10, wherein the first small hole is made by punching in a direction toward the second sheet-metal part.

13. An image forming apparatus according to claim 10, wherein the first small hole has a diameter smaller than that of the first pilot hole.

14. An image forming apparatus according to claim 10, further comprising a second pilot hole made in the second sheet-metal part, the second pilot hole being smaller than the screw.

15. An image forming apparatus according to claim 14, further comprising a second small hole made in the second sheet-metal part, at a position to face to the first small hole.

16. An image forming apparatus according to claim 15, wherein the second small hole is made by punching in a direction toward the first sheet-metal part.

17. An image forming apparatus according to claim 15, wherein the second small hole has a diameter smaller than that of the second pilot hole.

18. An image forming apparatus according to claim 10, wherein the second sheet-metal part has a knurled portion on the contact surface, at a position to face to the first small hole.
